(19) United States
(12) Patent Application Publication
(10) Pub. No.: US 2003/0031028 A1
(43) Pub. Date: Feb. 13, 2003

(54) Vehicle emergency warning light having TIR lens, LED light engine and heat sink

(76) Inventors: Timothy B. Murray, Kirkwood, MO (US); Paul L. Stein, St. Peters, MO (US); Dennis A. Dohogne, St. Peters, MO (US); Robert E. Kreutzer, Columbia, IL (US); Steven J. Muren, Belleville, IL (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/927,093

(22) Filed: Aug. 9, 2001

(51) Int. Cl. F21S 8/10; F21V 21/00

(52) U.S. Cl. 362/545; 362/493; 362/547; 362/240

(57) ABSTRACT

An emergency warning light for a vehicle including an LED light engine in contact with a heat sink and covered by a lens including a plurality of total internal reflection (TIR) surface configurations corresponding to the LEDs. A constant current step up power supply circuit energizes the LEDs.

### BACKGROUND OF THE INVENTION

The invention generally relates to lighting and, in particular, to a light including light emitting diodes (LEDs) for generating emergency signals.

Use of LEDs for signaling has been increasing as LEDs increase in intensity and decrease in cost. These is a need for an emergency vehicle warning light which employs LEDs in a modular configuration.

### SUMMARY OF THE INVENTION

In one form, the invention is an emergency warning light comprising a heat sink, a light engine and a lens. The light engine is adapted to be in thermal contact with the heat sink, the light engine including an array of LEDs generating light adapted for use as an emergency warning signal. The lens is positioned adjacent the light engine for transmitting the light generated by the LEDs. The lens includes a plurality of total internal reflection (TIR) surface configurations, each one of the TIR surface configurations corresponding to one of the LEDs of the array.

In another form, the invention is a light bar for a vehicle comprising a support; a first module comprising a heat sink, a light engine and a lens; and an enclosure. The heat sink is adapted to engage the support of the light bar. The light engine is adapted to be in thermal contact with the heat sink, the light engine including an array of LEDs generating light adapted for use as an emergency warning signal. The lens is positioned adjacent the light engine for transmitting the light generated by the LEDs of the array. The lens includes a plurality of TIR surface configurations, each one of the TIR surface configurations corresponding to one of the LEDs of the array. The enclosure encloses the support and the first module. The enclosure is adapted to be mounted on the vehicle.

In another form, the invention is an emergency warning light for use on a vehicle comprising a support, a light engine, a lens, a power supply circuit and an enclosure. The support is adapted to be a heat sink. The light engine is adapted to be in thermal contact with the support. The light engine includes an array of LEDs generating light adapted for use as an emergency warning signal. The lens is positioned adjacent the light engine for transmitting the light generated by the LEDs of the array, the lens including a plurality of TIR surface configurations. Each one of the TIR surface configurations corresponds to one of the LEDs of the array. The power supply circuit energizes the light engine. The enclosure encloses the support, the light engine, the power supply and the lens. The enclosure is adapted to be mounted on the vehicle.

The light of the invention has a number of advantages of the prior art. For example, the configuration of the invention results in a light module which meets or exceeds various minimum illumination requirements while allowing the light module to have a size of about 1×4 inches so that the light module can be accommodated within a space of a light bar in which an incandescent or strobe module is usually located. The invention provides lighting of sufficient brightness to provide an emergency warning. The invention can provides warning lights of white, red, blue or amber in color, depending on the type of LEDs employed. The invention can be programmed to provide a steady burning, a flashing or a stobing warning signal. The modules of the invention may be synchronized with each other. The invention facilitates surface mounting of water resistant lighting packages. The invention dissipates heat generated by the LEDs and increases LED efficiency. The modules provide increased light output and increased useful life. The lenses of the invention may be clear or tinted to provide various colors.

Other objects and features will be in part apparent and in part pointed out hereinafter.

### BRIEF DESCRIPTION OF THE DRAWINGS

FIG. 1 is a vertical cross sectional view of an emergency warning light according to the invention including a heat sink, a single light engine, a lens and a power supply circuit.

FIG. 2 is a perspective view of the inner surface of a lens of an emergency warning light according to the invention illustrating the TIR surface configurations.

FIG. 3 is horizontal cross sectional view taken along lines 3-3 of the lens of FIG. 2.

FIG. 4 is a block diagram of a constant current step up power supply circuit for a light engine for an emergency warning light according to the invention.

FIG. 5 is a vertical cross sectional view of an emergency warning light according to the invention including a heat sink, two light engines, two lenses and two power supply circuits.

FIG. 6 is a perspective view of an emergency warning light bar according to the invention showing the lower enclosure section and including a module having a heat sink, two light engines, two lenses and two power supply circuits, the module being mounted to a support.

FIG. 7 is horizontal cross sectional view taken along lines 7-7 of the light bar of FIG. 6.

FIG. 8 is a perspective view of an emergency warning light bar according to the invention showing the lower enclosure section and including a module having a heat sink, one light engine, one lens and one power supply circuit, the module being mounted to a support.

FIG. 9 is a perspective view of a stand alone emergency warning light according to the invention including a mounting bracket with suction cups.

FIG. 10 is an exploded perspective view of the stand alone emergency warning light of FIG. 9.

FIG. 11 is an exploded side view of the stand alone emergency warning light of FIG. 9.

FIG. 12 is an exploded perspective view of an emergency warning light according to the invention including a heat sink, eight light engines, eight lenses and eight power supply circuits in a linear array wherein each of the light engines is selectively, sequentially energized to provide a traffic direction directing signal.

Corresponding reference characters indicate corresponding parts throughout the drawings.

### DESCRIPTION OF THE PREFERRED EMBODIMENTS

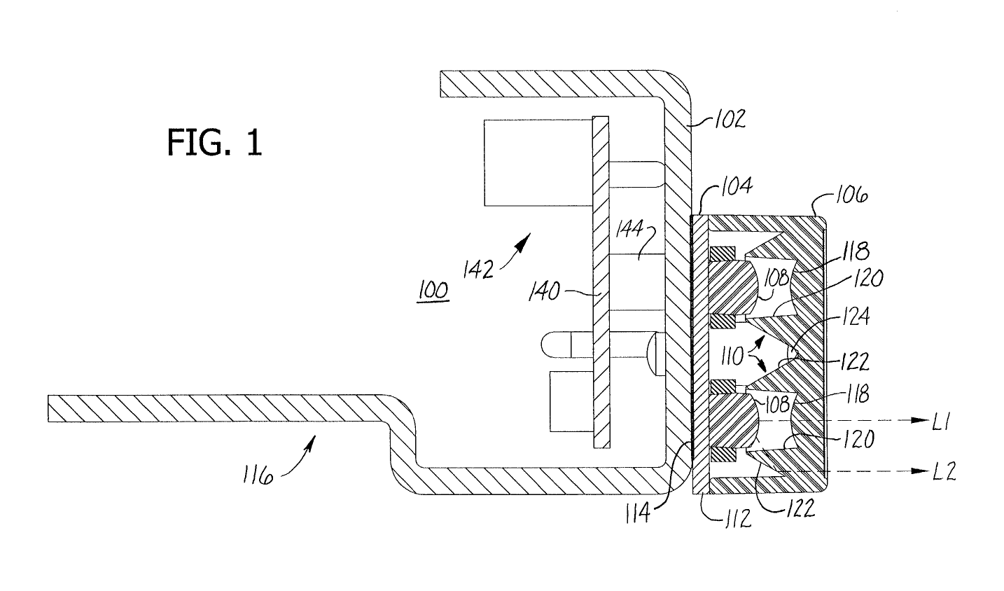

FIG. 1 is a vertical, cross-sectional view of an emergency warning light 100 according to the invention including a heat sink 102, a single light engine 104 and a lens 106. In one form, the heat sink 102 is a metallic bracket for dissipating heat generated by the light engine 104. The light engine may be any off the shelf light engine which includes a plurality of LEDs 108 in an array such as model no. 25-0303, manufactured by LumiLeds Lighting. The LEDs generate light adapted to be used as an emergency warning signal, particularly on vehicles such as fire trucks, police cars and ambulances. Lens 106 is positioned over and adjacent the light engine 104. Lens 106 transmits the light generated by the LEDs 108. The lens 106 includes a plurality of total internal reflection (TIR) surface configurations 110 which will be described in greater detail below. Each one of the TIR surface configurations 110 corresponds to and is positioned over one of the LEDs 108 of the array to collect and direct the light from its associated LED.

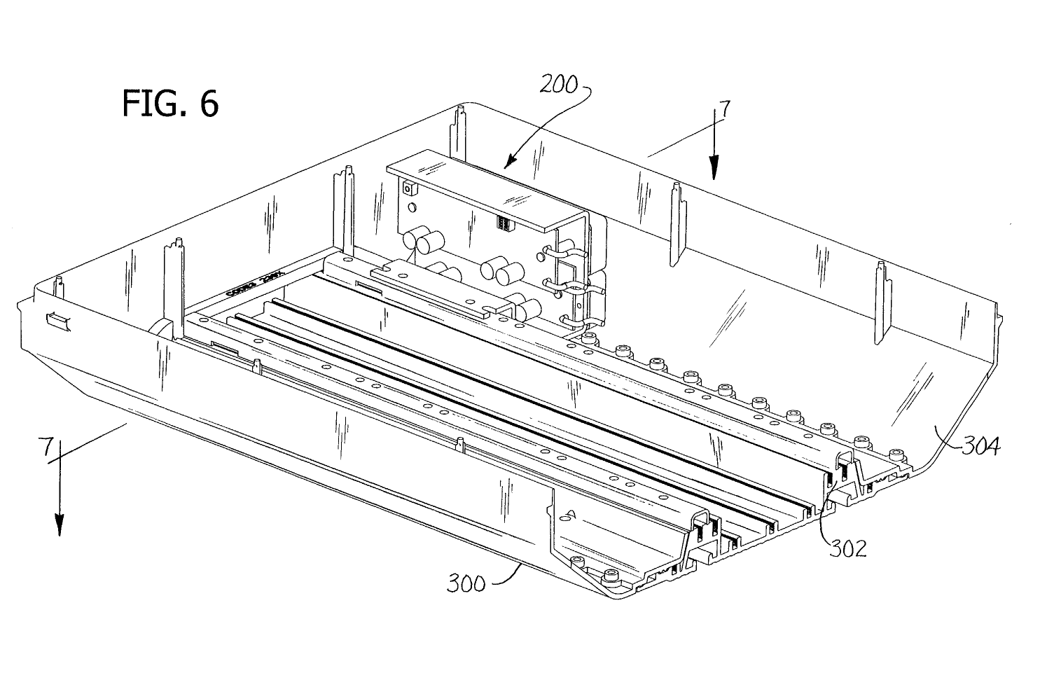

The light engine 104 is adapted to be in thermal communication or contact with the heat sink 102 although not necessarily in direct physical contact. Frequently, such light engines such as the light engine 104 illustrated in FIG. 1 include a heat absorbing substrate 112 on which the array of LEDs 108 is mounted. Preferably, a thermal conducting pad 114 is positioned between the substrate 112 and the heat sink 102 for transmitting heat generated by the array of LEDs 108 and absorbed by the substrate 112 to the heat sink 102. In general, it is also contemplated that the LEDs 108 may be directly mounted to the heat sink 102. In any case, the flat surface of the heat sink 102 is mated to the obverse side of the light engine 104 for good thermal contact. As shown in FIG. 1, the heat sink 102 includes an integral mounting portion 116 adapted to engage a support (not shown). Alternatively, a separate mounting bracket (see FIGS. 6, 7 and 12) may be provided for supporting the heat sink 102, the light engine 104 and the lens 106 on a support.

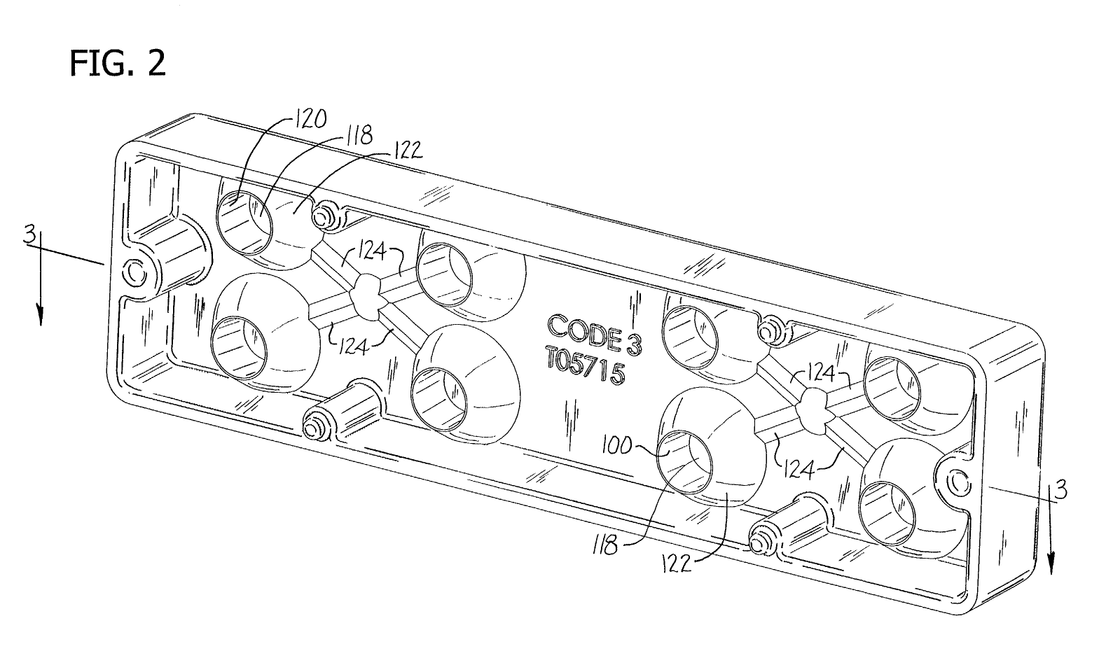

As shown in FIGS. 1 and 2, each of the TIR surface configurations 110 comprises a convex wall 118, an inner substantially cylindrical side wall 120 and an angled outer side wall 122. Light rays L1 emitted by the LEDs 108 directly toward the wall 118 are collimated by wall 118 and provide an emergency warning signal. In addition, light rays L2 emitted by the LEDs 108 toward the inner side wall 120 are internally transmitted through the inner side wall 120 and reflected by the angled outer side wall 122 in a direction which is generally parallel to collimated light rays L1 to provide the emergency warning signal. Other scattered light, not illustrated, is also transmitted by lens 106 as part of the emergency warning signal. In one form as shown in FIG. 2, the lens 106 comprises an injected molded transparent plastic material having at least one internal runner 124 connected to and integral with the TIR surface configurations 110. The runners 124 are adapted to facilitate formation of the TIR surface configuration 110 connected to each of the runners during the injection molding process of the lens 106.

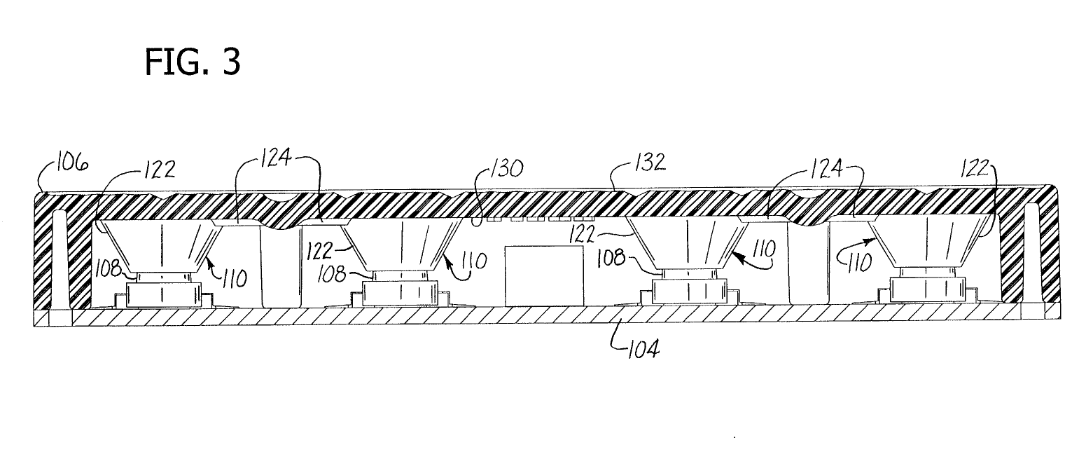

As shown in FIG. 3, the lens 106 has an inner surface 130 and an outer surface 132 in opposing relation to each other. The TIR surface configurations 110 project from the inner surface 130 which faces the light engine 104 so that the configurations 110 collect and direct light generated by the LEDs 108 of the light engine 104. The outer surface 132 comprises a distributing surface, such as a Fresnell lens or a non-planar surface, for distributing, spreading and/or dispersing light collected by the TIR surface configurations 110.

FIG. 1 also illustrates a printed circuit board (PCB) 140 having a power supply circuit 142 thereon for energizing the light engine 104. As shown in FIG. 1, the power supply circuit 142 is adapted to be supported by the heat sink 102. In particular, stand-offs 144 at either or both ends of the PCB 140 separate and support the PCB from the heat sink 102. However, it is also contemplated that the power supply circuit 142 may not be a part of the module as shown in FIG. 1 and that the printed circuit board 140 may be remote from the module of FIG. 1 and remote from the light engine 104. In such a remote configuration, each light engine 104 would be connected to a centralized power supply circuit 142 by a harness.

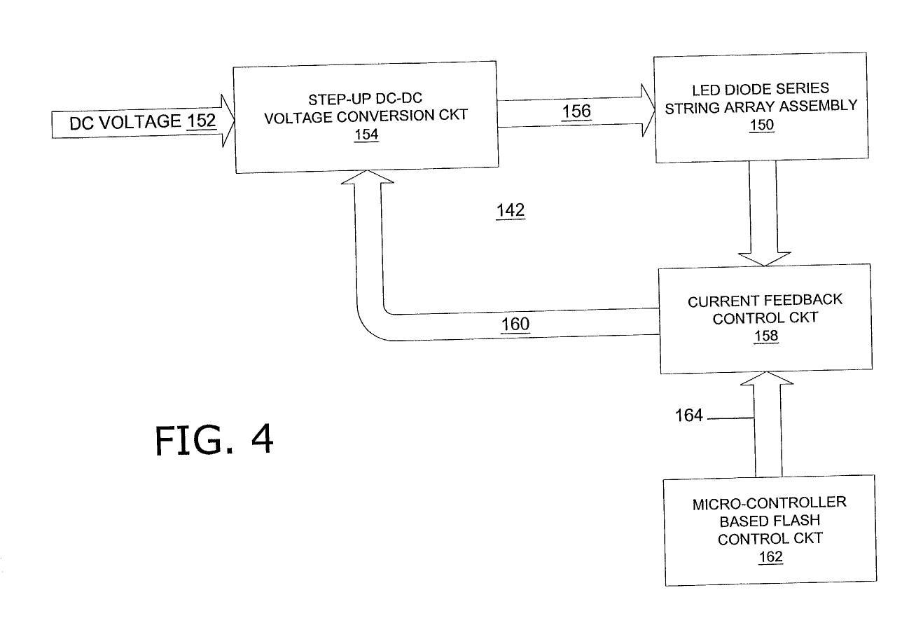

The light 100 as shown in FIG. 1 is for use on a vehicle such as an emergency vehicle including a police, fire or ambulance vehicle. Such vehicles generally have an electrical system including a battery supplying an unregulated dc voltage 152. FIG. 4 is a block diagram of a power supply circuit for providing a substantially constant drive current to the light engine 104. In one form, the light engine 104 comprises an LED series string array assembly 150. The power supply circuit 142 is adapted to be connected to the dc circuit 142 includes a step-up dc-dc voltage conversion circuit 154 receiving the dc voltage 152 and providing a stepped-up dc voltage 156 to the LED series string array assembly 150 having a magnitude sufficient to illuminate the LEDs. A current feedback control circuit 158 in series with the LED series string array assembly 150 senses the current through the diode array and provides feedback 160 to the conversion circuit 154. The conversion circuit is responsive to the feedback 160 for controlling the stepped-up dc voltage 156 as a function of the feedback. This feedback allows the LED diode series string array assembly 150 to be operated with substantially constant current over varying load conditions. Since LEDs are current controlled devices, circuit 142 provides a constant current driver scheme which operates the LEDs reliably and efficiently. In addition, utilizing the LEDs in a series string diode array assembly allows the intensity of the output light of the LED array to be kept substantially constant and substantially independent of fluctuations caused by diode forward voltage, load and/or temperature variations. Optionally, a flash control circuit 162 may interface with the current feedback control circuit 158. The flash control circuit 162 comprises a micro-controller based flash control providing a programmable flash control signal to the control circuit 158 to allow user selectable warning signals and/or patterns to be generated. As a result, the current feedback circuit 158 is responsive to the flash control signal 164 for selectively energizing the LED series string array assembly 150 to create a flashing emergency warning light signal.

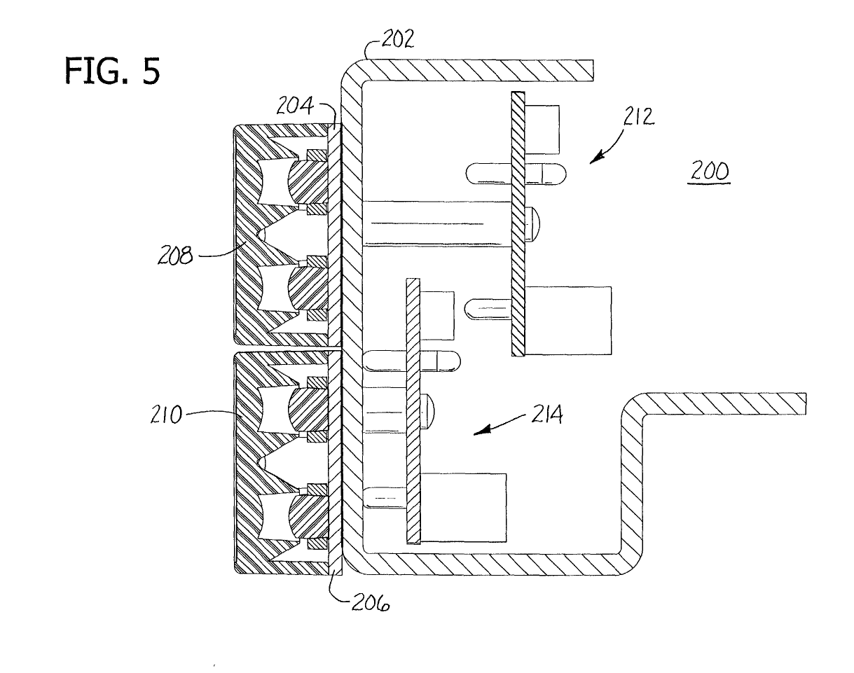

FIG. 1 illustrates one modular configuration of the light 100 according to the invention including a single light engine and a single lens. FIG. 5 illustrates another modular configuration of the light according to the invention. FIG. 5 is a vertical, cross-sectional view of a dual light engine module 200 according to the invention including a heat sink 202, two light engines 204 and 206, two lenses 208 and 210, and two power supply circuits 212 and 214.

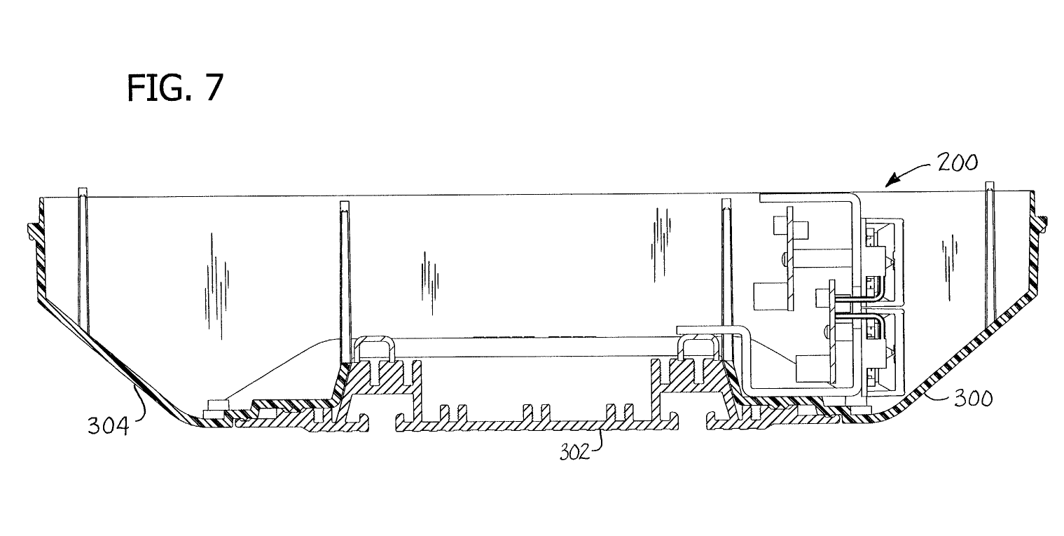

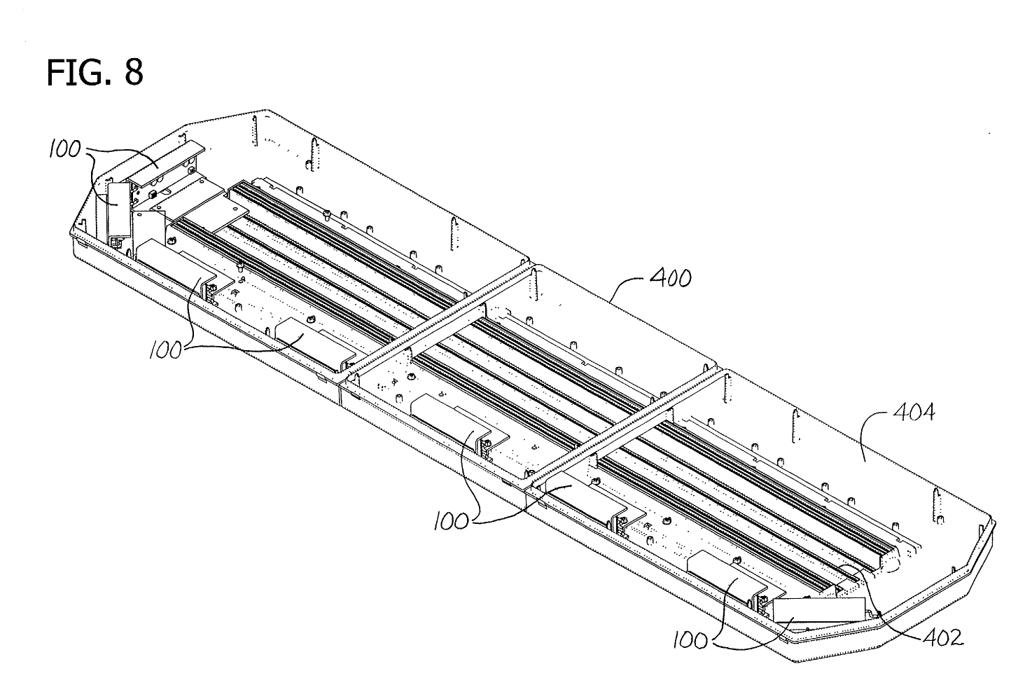

FIGS. 6 and 7 show the dual light engine module 200 of FIG. 5 in a light bar 300 in one of several positions in which a module may be located. FIG. 8 shows a light bar 400 having eight single light engine modules 100 positioned therein. The light bars 300, 400 include a support 302, 402 (such as an extruded aluminum channel), a plurality of one or more modules in various positions within the light bar and an enclosure enclosing the support 302, 402 and the modules. The enclosure is usually a transparent shell of a plastic material such as polycarbonate having a lower shell portion 304, 404 and an upper shell portion (not shown) which interfit and are adapted to be mounted on a vehicle requiring emergency warning lighting. As illustrated in FIGS. 6, 7 and 8, each of the modules includes a power supply circuit adapted to be supported by the heat sink of the module for energizing the light engine or engines of the module. However, it is also contemplated that the power supply circuit may be a centrally located circuit for supplying power to all the modules or at least all the LED modules within the light bar. Preferably, the power supply circuit is within the enclosure for energizing the light modules.

In one preferred aspect of the invention, the LED modules 100 and 200 are placed in a light bar with other modules employing incandescent light sources such as HID or halogen bulbs for use together to create an emergency warning signal for warning observers remote from the vehicle on which the light bar is located. In this configuration, the enclosure 306, 406 encloses the support 302, 402, the LED modules 100, 200, and the incandescent light modules.

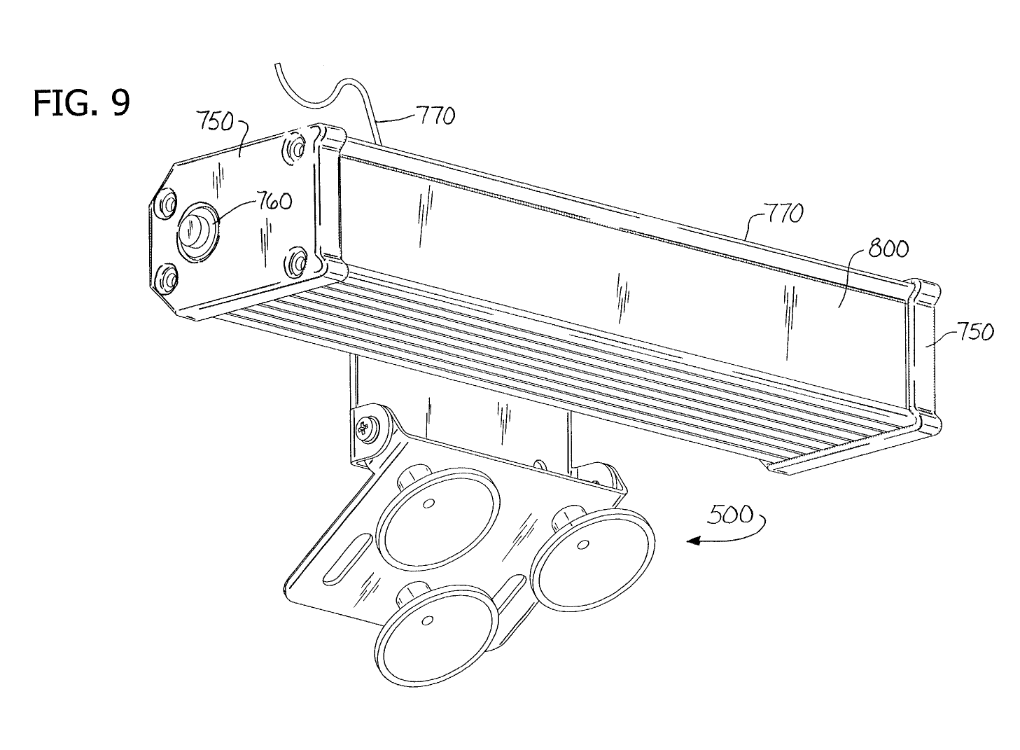

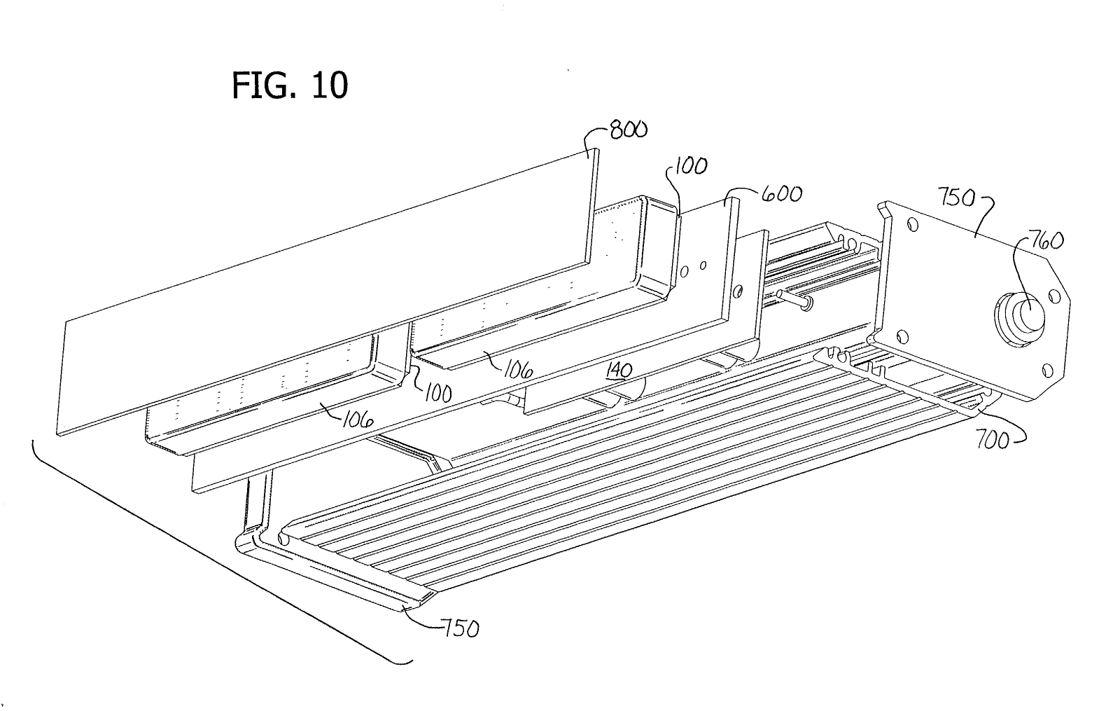

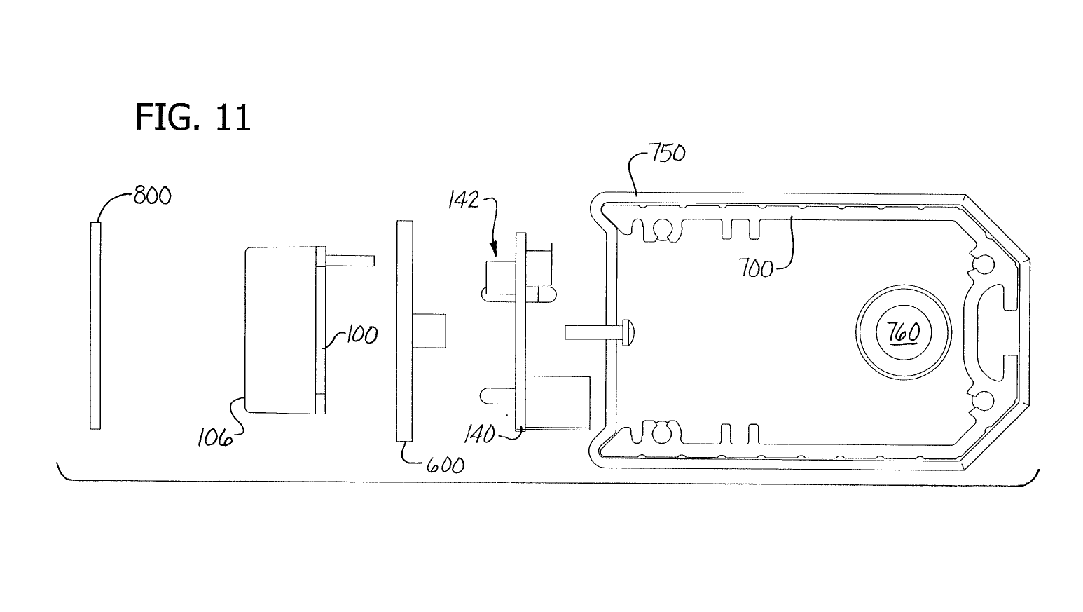

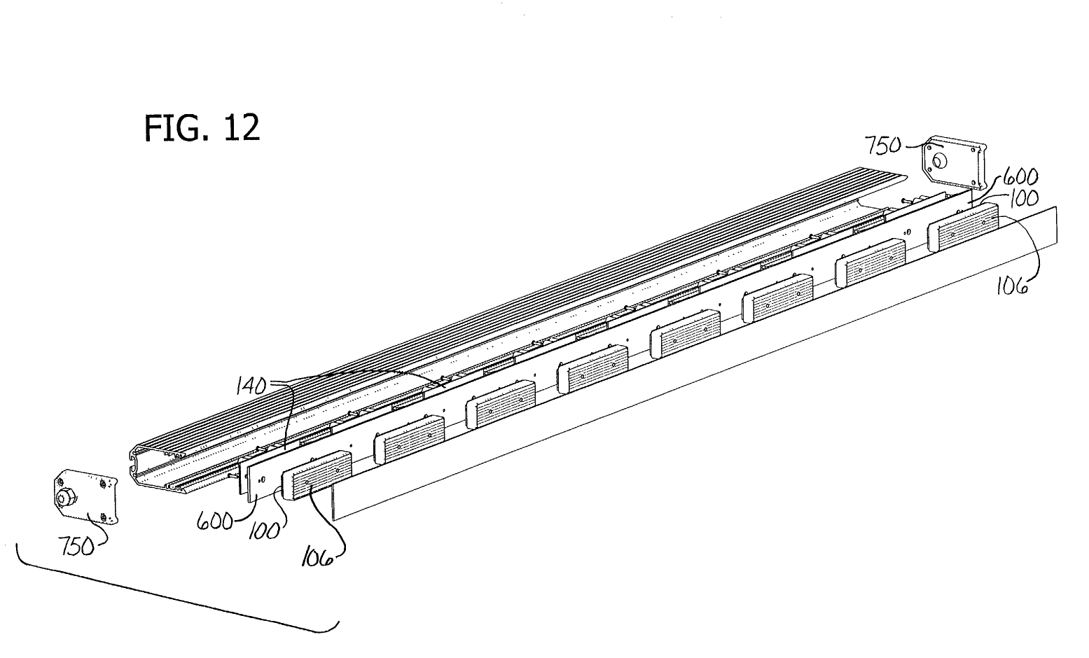

FIGS. 9, 10 and 11 illustrate a stand alone version of the light according to the invention. This stand alone version is a two light engine embodiment intended to be mounted by a bracket such as a suction cup bracket 500 illustrated in FIG. 9. The modules and, consequently, the engines are positioned end to end as compared to the side to side positioning of the engines in the dual module 200 of FIG. 5. The embodiment of FIG. 12 includes eight light modules 100 end to end in a linear row which are selectively, sequentially energized to provide a traffic direction directing visual signal. Usually, the light engines are sequentially energized left to right to indicate that traffic should move right, or sequentially energized right to left to indicate that traffic should move left, or energized from the center outwardly to indicate that traffic should move right or left. Alternatively, the light engines may be flashed in a pattern to provide a warning. Both embodiments include a support 600 which functions as a heat sink. The light engines 100 are adapted to be in thermal contact with the support 600 and each light engine 100 includes an array of LEDs generating light adapted for use as an emergency warning signal. Lenses 106 positioned over each of the light engines 100 transmit light generated by the LEDs of the array. Each lens 106 includes a plurality of TIR surface configurations, each one of the TIR surface configurations corresponding to one of the LEDs of the array. The PCB 140 with power supply circuit 142 for energizing each light engine is also illustrated. A separate circuit (as shown) is contemplated although a single centrally located circuit for all light engines is also contemplated. An enclosure 700 encloses the support, the light engine and the power supply and the lens. The enclosure 700 may be metal and may be in thermal contact with the support 600 to function as an additional heat sink to dissipate heat from the LEDs. End plates 750 engage the ends of the enclosure 700. Preferably, a transparent lens cover 800 is positioned over the lenses 106 and engages the enclosure 700 and end plates 750 to form a sealed package. FIGS. 9-11 also show a switch 760 for use by an operator to control the light and a wire 770 for connecting the light to a dc voltage. The enclosure is adapted to be mounted on a vehicle. The linear design of the embodiment of FIG. 12 may be flush mounted to a vehicle. The embodiment of FIGS. 9-11 is primarily intended for mounting internally within a passenger compartment of a vehicle. Any of the heat conducting elements may include fins or other elements to transfer heat to air or other parts of the apparatus.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An emergency warning light comprising:
a heat sink;
a light engine adapted to be in thermal contact with the heat sink, the light engine including an array of LEDs generating light adapted for use as an emergency warning signal; and
a lens positioned adjacent the light engine for transmitting the light generated by the LEDs, the lens including a plurality of total internal reflection (TIR) surface configurations, each one of the TIR surface configurations corresponding to one of the LEDs of the array.

2. The light of claim 1 comprising a power supply circuit for energizing the light engine, the circuit adapted to be supported by the heat sink.

3. The light of claim 1 for use on a vehicle having a power source supplying a dc voltage and wherein the light engine comprises an LED series string array assembly, the light further comprising a power supply circuit adapted to be connected to the dc voltage, the power supply circuit comprising:
a step-up dc-dc voltage conversion circuit receiving the dc voltage and providing a stepped up dc voltage to the LED series string array assembly; and
a current feedback control circuit in series with the LED series string array assembly and providing feedback to the conversion circuit wherein the conversion circuit is responsive to the feedback for controlling the stepped up dc voltage as a function of the feedback; and
wherein the heat sink, the light engine, the lens and the power supply circuit for a unit adapted to be mounted on the vehicle.

4. The light of claim 3 further comprising a flash control circuit providing a flash control signal and wherein the current feedback circuit is responsive to the flash control signal for selectively energizing the LED series string array assembly to create a flashing emergency warning light signal.

5. The light of claim 1 wherein the light engine includes a heat absorbing substrate on which the array of LEDs is mounted and further comprising a thermal conducting pad between the substrate and the heat sink for transmitting heat generated by the array of LEDs and absorbed by the substrate to the heat sink.

6. The light of claim 1 wherein the heat sink includes a integral mounting portion adapted to engage a support structure on a vehicle.

7. The light of claim 1 further comprising a mounting bracket for supporting the heat sink, the light engine and the lens on a support structure on a vehicle.

8. The light of claim 1 wherein the TIR surface configurations each comprises a convex wall, an inner side wall and an outer side wall and wherein the lens comprises an injection molded material having at least on internal runner connected to the TIR surface configurations, the runner adapted to facilitate formation of the TIR surface configuration connected thereto during injection molding of the lens.

9. The light of claim 8 wherein the lens has opposing inner and outer surfaces, wherein the TIR surface configurations are on the inner surface facing the light engine and collect light generated by the LEDs of the light engine and wherein the outer surface comprises a distributing surface for distributing light collected by the TIR surface configurations.

10. The light of claim 1 wherein the lens has opposing inner and outer surfaces, wherein the TIR surface configurations are on the inner surface facing the light engine and collect light generated by the LEDs of the light engine and wherein the outer surface comprises a distributing surface for distributing light collected by the TIR surface configurations.

11. The light of claim 1 for use in a light bar having a support, the light bar adapted to be mounted on a vehicle, the emergency warning light comprising a module and wherein the heat sink is adapted to engage the support of the light bar.

12. The light of claim 11 wherein the heat sink includes an integral mounting portion connected to the support of the light bar and further comprising a power supply circuit for energizing the light engine, the circuit adapted to be supported by the heat sink.

13. The light of claim 12 further comprising:
a second light engine adapted to be in thermal contact with the heat sink, the second light engine including a second array of LEDs generating light adapted for use as an emergency warning signal; and
a second lens positioned adjacent the second light engine for transmitting the light generated by the LEDs of the second array, the second lens including a plurality of second TIR surface configurations, each one of the second TIR surface configurations corresponding to one of the LEDs of the second array.

14. The light of claim 11 for use on a vehicle having a power source supplying a dc voltage and wherein the light engine comprises an LED series string array assembly, the light further comprising a power supply circuit adapted to be connected to the dc voltage, the power supply circuit comprising:
a step-up dc-dc voltage conversion circuit receiving the dc voltage and providing a stepped up dc voltage to the LED series string array assembly; and
a current feedback control circuit in series with the LED series string array assembly and providing feedback to the conversion circuit wherein the conversion circuit is responsive to the feedback for controlling the stepped up dc voltage as a function of the feedback; and
wherein the heat sink, the light engine, the lens and the power supply circuit for a unit adapted to be mounted on the vehicle.

15. The light of claim 11 further comprising a flash control circuit providing a flash control signal and wherein the current feedback circuit is responsive to the flash control signal for selectively energizing the LED series string array assembly to create a flashing emergency warning light signal.

16. The light of claim 11 wherein the lens has opposing inner and outer surfaces, wherein the TIR surface configurations are on the inner surface facing the light engine and collect light generated by the LEDs of the light engine and wherein the outer surface comprises a distributing surface for distributing light collected by the TIR surface configurations.

17. The light of claim 11 wherein the light engine includes a heat absorbing substrate on which the array of LEDs is mounted and further comprising a thermal conducting pad between the substrate and the heat sink for transmitting heat generated by the array of LEDs and absorbed by the substrate to the heat sink.

18. The light of claim 11 wherein the heat sink includes a integral mounting portion adapted to engage a support structure on a vehicle.

19. The light of claim 11 wherein the TIR surface configurations each comprises a convex wall, an inner side wall and an outer side wall and wherein the lens comprises an injection molded material having at least on internal runner connected to the TIR surface configurations, the runner adapted to facilitate formation of the TIR surface configuration connected thereto during injection molding of the lens.

20. The light of claim 11 for use on a vehicle having a power source supplying a dc voltage and wherein the light engine comprises an LED series string array assembly, the light further comprising a power supply adapted to be connected to the dc voltage for energizing the assembly, the power supply comprising a constant current step up power supply circuit.

21. A light bar for a vehicle comprising:
a support;
a first module comprising:
a heat sink adapted to engage the support of the light bar;
a light engine adapted to be in thermal contact with the heat sink, the light engine including an array of LEDs generating light adapted for use as an emergency warning signal; and
a lens positioned adjacent the light engine for transmitting the light generated by the LEDs of the array, the lens including a plurality of TIR surface configurations, each one of the TIR surface configurations corresponding to one of the LEDs of the array; and
an enclosure enclosing the support and the first module, the enclosure adapted to be mounted on the vehicle.

22. The light bar of claim 21 wherein the module comprises a power supply circuit adapted to be supported by heat sink for energizing the light engine.

23. The light bar of claim 21 further comprising a power supply circuit within the enclosure for energizing the light engine.

24. The light of claim 21 for use on a vehicle having a power source supplying a dc voltage and wherein the light engine comprises an LED series string array assembly, the light further comprising a power supply circuit adapted to be connected to the dc voltage, the power supply circuit comprising:
a step-up dc-dc voltage conversion circuit receiving the dc voltage and providing a stepped up dc voltage to the LED series string array assembly; and
a current feedback control circuit in series with the LED series string array assembly and providing feedback to the conversion circuit wherein the conversion circuit is responsive to the feedback for controlling the stepped up dc voltage as a function of the feedback; and
wherein the heat sink, the light engine, the lens and the power supply circuit for a unit adapted to be mounted on the vehicle.

25. The light of claim 21 further comprising a flash control circuit providing a flash control signal and wherein the current feedback circuit is responsive to the flash control signal for selectively energizing the LED series string array assembly to create a flashing emergency warning light signal.

26. The light of claim 21 wherein the TIR surface configurations each comprises a convex wall, an inner side wall and an outer side wall and wherein the lens comprises an injection molded material having at least on internal runner connected to the TIR surface configurations, the runner adapted to facilitate formation of the TIR surface configuration connected thereto during injection molding of the lens.

27. The light bar of claim 21 further comprising:
a second module comprising:
a second heat sink adapted to engage the support of the light bar;
a second light engine adapted to be in thermal contact with the second heat sink, the second light engine including a second array of LEDs generating light adapted for use as a second emergency warning signal; and
a second lens positioned adjacent the second light engine for transmitting the light generated by the LEDs of the second array, the lens including a second plurality of TIR surface configurations, each one of the TIR surface configurations corresponding to one of the LEDs of the second array; and
wherein the enclosure encloses the support, the first module and the second module, the enclosure adapted to be mounted on the vehicle.

28. The light bar of claim 27 further comprising at least one power supply circuit within the enclosure for sequentially energizing the first and second light engines to produce a traffic direction directing signal.

29. The light bar of claim 27 wherein the first module comprises a first power supply circuit within the enclosure adapted to be supported by first heat sink for energizing the first light engine and wherein the second module comprises a second power supply circuit within the enclosure adapted to be supported by second heat sink for energizing the second light engine.

30. The light bar of claim 29 wherein the first and second power supply circuits sequentially energizes the first and second light engines, respectively, to produce a traffic direction directing signal.

31. The light bar of claim 27 further comprising a central power supply circuit within the enclosure for energizing the first and second light engines.

32. The light bar of claim 31 wherein the central power supply circuit sequentially energizes the first and second light engines to produce a traffic direction directing signal.

33. The light of claim 21 wherein the light engine includes a heat absorbing substrate on which the array of LEDs is mounted and further comprising a thermal conducting pad between the substrate and the heat sink for transmitting heat generated by the array of LEDs and absorbed by the substrate to the heat sink.

34. The light of claim 21 wherein the TIR surface configurations each comprises a convex wall, an inner side wall and an outer side wall and wherein the lens comprises an injection molded material having at least on internal runner connected to the TIR surface configurations, the runner adapted to facilitate formation of the TIR surface configuration connected thereto during injection molding of the lens.

35. The light of claim 21 wherein the lens has opposing inner and outer surfaces, wherein the TIR surface configurations are on the inner surface facing the light engine and collect light generated by the LEDs of the light engine and wherein the outer surface comprises a distributing surface for distributing light collected by the TIR surface configurations.

36. An emergency warning light for use on a vehicle comprising:
a support adapted to be a heat sink;
a light engine adapted to be in thermal contact with the support, the light engine including an array of LEDs generating light adapted for use as an emergency warning signal;
a lens positioned adjacent the light engine for transmitting the light generated by the LEDs of the array, the lens including a plurality of TIR surface configurations, each one of the TIR surface configurations corresponding to one of the LEDs of the array;
a power supply circuit for energizing the light engine; and
an enclosure enclosing the support, the light engine, the power supply and the lens, the enclosure adapted to be mounted on the vehicle.

37. The light of claim 36 further comprising a transparent cover positioned adjacent and spaced from the first lens and supported by the enclosure for transmitting light transmitted by the first lens.

38. The light of claim 36 further comprising:
a second light engine adapted to be in thermal contact with the support, the second light engine including a second array of LEDs generating light adapted for use as an emergency warning signal;
a second lens positioned adjacent the second light engine for transmitting the light generated by the LEDs of the second array, the second lens including a second plurality of second TIR surface configurations, each one of the second TIR surface configurations corresponding to one of the LEDs of the second array;
wherein the power supply circuit energizes the second light engine and wherein the enclosure encloses the support, the light engine, the power supply, the lens, the second light engine and the second lens, the enclosure adapted to be mounted on the vehicle.

39. The light of claim 38 further comprising:
a third light engine adapted to be in thermal contact with the support, the third light engine including a third array of LEDs generating light adapted for use as an emergency warning signal;
a third lens positioned adjacent the third light engine for transmitting the light generated by the LEDs of the third array, the third lens including a third plurality of third TIR surface configurations, each one of the third TIR surface configurations corresponding to one of the LEDs of the third array;
wherein the power supply circuit selectively, sequentially energizes the first, second and third light engines to provide a traffic direction directing visual signal and wherein the enclosure encloses the support, the light engine, the power supply, the lens, the second light engine, the second lens, the third light engine and the third lens, the enclosure adapted to be mounted on the vehicle.

40. The light of claim 31 further comprising a bracket adapted to engage the light and the vehicle for supporting the light on the vehicle.

41. The light of claim 36 comprising a power supply circuit for energizing the light engine, the circuit adapted to be supported by the support.

42. The light of claim 36 for use on a vehicle having a power source supplying a dc voltage and wherein the light engine comprises an LED series string array assembly, the light further comprising a power supply circuit adapted to be connected to the dc voltage, the power supply circuit comprising:
a step-up dc-dc voltage conversion circuit receiving the dc voltage and providing a stepped up dc voltage to the LED series string array assembly; and
a current feedback control circuit in series with the LED series string array assembly and providing feedback to the conversion circuit wherein the conversion circuit is responsive to the feedback for controlling the stepped up dc voltage as a function of the feedback; and
wherein the light engine, the lens and the power supply circuit form a unit adapted to be mounted on the vehicle.

43. The light of claim 36 further comprising a flash control circuit providing a flash control signal and wherein the current feedback circuit is responsive to the flash control signal for selectively energizing the LED series string array assembly to create a flashing emergency warning light signal.

44. The light of claim 36 wherein the light engine includes a heat absorbing substrate on which the array of LEDs is mounted and further comprising a thermal conducting pad between the substrate and the support for transmitting heat generated by the array of LEDs and absorbed by the substrate to the support.

45. The light of claim 36 wherein the lens has opposing inner and outer surfaces, wherein the TIR surface configurations are on the inner surface facing the light engine and collect light generated by the LEDs of the light engine and wherein the outer surface comprises a distributing surface for distributing light collected by the TIR surface configurations.

46. The light of claim 36 wherein the TIR surface configurations each comprises a convex wall, an inner side wall and an outer side wall and wherein the lens comprises an injection molded material having at least on internal runner connected to the TIR surface configurations, the runner adapted to facilitate formation of the TIR surface configuration connected thereto during injection molding of the lens.
